(19) United States
(12) Patent Application Publication
(10) Pub. No.: US 2020/0339084 A1
(43) Pub. Date: Oct. 29, 2020

(54) CONTROL SYSTEM OF MOTOR-DRIVEN MOVEABLE PLATFORM AND METHOD OF CONTROLLING THE SAME

(71) Applicant: New Era AI Robotic Inc., Taipei City (TW)

(72) Inventors: Chun-Chi LIN, TAIPEI CITY (TW); Ka-Weng CHU, TAIPEI CITY (TW); Ting-Shuo CHEN, TAIPEI CITY (TW)

(21) Appl. No.: 16/433,444

(22) Filed: Jun. 6, 2019

(30) Foreign Application Priority Data
Apr. 25, 2019 (CN) 201910341037.3

(51) Int. Cl. B60T 8/32

(52) U.S. Cl. CPC B60T 8/321

(57) ABSTRACT

A control system of a motor-driven moveable platform is provided to control speed of a moveable platform. The control system of the motor-driven moveable platform includes a subtractor, a controller, and a signal converter. The subtractor produces an error speed, the controller produces a speed control signal, and the signal converter produces a speed drive signal including an accelerated drive signal and a decelerated drive signal. The accelerated drive signal and the decelerated drive signal are provided to control acceleration and deceleration of the moveable platform.

### BACKGROUND OF THE INVENTION

### Technical Field

The present disclosure relates to a control system of a moveable platform and a method of controlling the same, and more particularly to a control system of a motor-driven moveable platform without additional braking mechanism and a method of controlling the same.

### Description of Related Art

The statements in this section merely provide background information related to the present disclosure and do not necessarily constitute prior art.

For existing robots with moveable platforms, the moveable platform is mainly driven to forward move by a motor. If the moveable platform needs to be decelerated, a braking force can be actively applied through an additional braking mechanism to brake the moveable platform. Alternatively, the moveable platform is passively decelerated without being driven by the motor. Therefore, the forward control and the deceleration control of the moveable platform are implemented. Moreover, the acceleration and deceleration control of the moveable platform with different loads is usually implemented by a human adjustment.

However, the existing problems associated with driving and controlling the moveable platform are: for the passively-decelerated moveable platform without being driven by the motor, if the actual speed of the moveable platform exceeds the target speed and needs to be decelerated, the moveable platform cannot be decelerated if no braking force provided by the additional brake mechanism. Therefore, not only the equipment costs and the maintenance costs are increased but also the control complexity is increased. Moreover, the acceleration and deceleration control of the moveable platform with different loads fails to be implemented automatically, accurately, and in real time.

### SUMMARY OF THE INVENTION

An object of the present disclosure is to solve the above-mentioned problems, and therefore the present disclosure provides a control system of a motor-driven moveable platform to control speed of a moveable platform. The control system of the motor-driven moveable platform includes a subtractor, a controller, and a signal converter. The subtractor receives a reference speed and an actual speed, and calculates a speed difference value between the reference speed and the actual speed to acquire an error speed. The controller receives the error speed, the actual speed, and an absolute value of a target speed to calculate a speed control signal. The signal converter receives the speed control signal, the actual speed, and the absolute value of the target speed to calculate a speed drive signal. The speed drive signal includes an accelerated drive signal and a decelerated drive signal. The accelerated drive signal and the decelerated drive signal are provided to control acceleration and deceleration of the moveable platform.

Accordingly, the deceleration of the moveable platform can be achieved without additional braking mechanism, which reduces equipment costs and maintenance costs, and reduces control complexity, and the closed-loop speed control tier the moveable platform is implemented to achieve the speed adjustment and control automatically, accurately, and in real time.

Another object of the present disclosure is to solve the above-mentioned problems, and therefore the present disclosure provides a method of controlling a motor-driven moveable platform, the method includes the steps of: (a) providing a reference speed, an actual speed, and an absolute value of a target speed, (b) providing a controller, and calculating a speed control signal by the controller according to the reference speed, the actual speed, and the absolute value of the target speed, (c) providing a signal converter, and calculating a speed drive signal by the signal converter according to the speed control signal, the actual speed, and the absolute value of the target speed, wherein the speed drive signal comprises an accelerated drive signal and a decelerated drive signal, and (d) controlling acceleration and deceleration of the moveable platform according to the accelerated drive signal and the decelerated drive signal.

Accordingly, the deceleration of the moveable platform can be achieved without additional braking mechanism, which reduces equipment costs and maintenance costs, and reduces control complexity; and the closed-loop speed control for the moveable platform is implemented to achieve the speed adjustment and control automatically, accurately, and in real time.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The present disclosure can be more fully understood by reading the following detailed description of the embodiment, with reference made to the accompanying drawings as follows:

FIG. 1 is a schematic view of a control system of a motor-driven moveable platform according to the present disclosure.

FIG. 2 is a schematic waveform of a reference speed according to the present disclosure.

FIG. 3 is a schematic waveform of a speed control of the motor-driven moveable platform according to the present disclosure.

FIG. 4 is a flowchart of a method of controlling the motor-driven moveable platform according to the present disclosure.

### DETAILED DESCRIPTION OF THE INVENTION

Reference will now be made to the drawing figures to describe the present disclosure in detail. It will be understood that the drawing figures and exemplified embodiments of present disclosure are not limited to the details thereof.

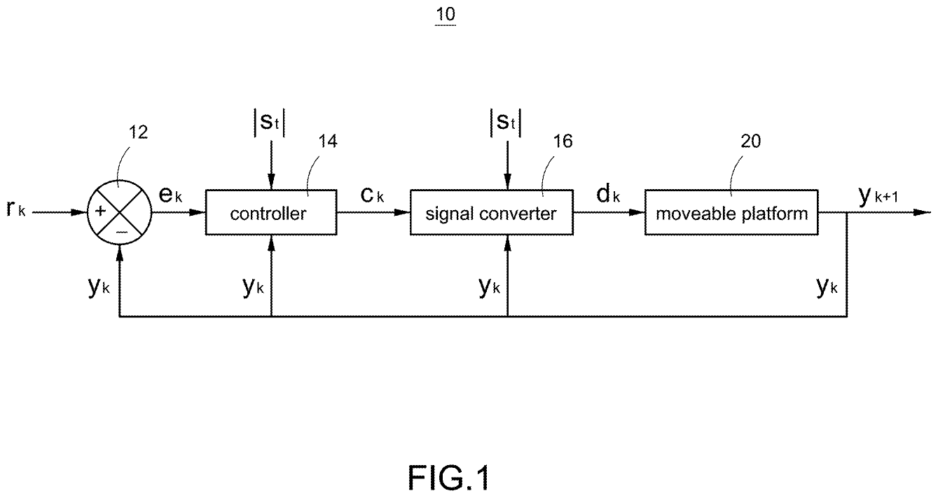

Please refer to FIG. 1, which shows a schematic view of a control system of a motor-driven moveable platform according to the present disclosure. The control system (hereinafter referred to “system”) includes a control mechanism 10 and a moveable platform 20. The control mechanism 10 provides a closed-loop speed control for the moveable platform 20 to make the speed of the moveable platform 20 reach to the desired target speed. The control mechanism 10 includes a subtractor 12, a controller 14, and a signal converter 16. In particular, the speed control of the moveable platform 20 means that left and right wheels of the moveable platform 20 are controlled, and therefore a moveable platform having movable and controllable left and right wheels is referred to as the moveable platform 20.

An output of the system is an actual speed yₖ of the moveable platform 20. The actual speed yₖ may be detected by a speed detector (not shown), and the detected actual speed yₖ is transmitted to the subtractor 12, and the subtractor 12 further receives a reference speed rₖ. In particular, the actual speed yₖ follows the reference speed rₖ for dynamic response. Specifically, the subtractor 12 receives the reference speed rₖ and the actual speed yₖ, and performs a subtraction operation between the reference speed rₖ and the actual speed yₖ to acquire an error speed eₖ, i.e., eₖ=rₖ−yₖ. Therefore, if the error speed eₖ is positive, it means that the actual speed yₖ is less (slower) than the reference speed rₖ, on the contrary, if the error speed eₖ is negative, it means that the actual speed yₖ is greater (faster) than the reference speed rₖ. Accordingly, the controller 14 and the signal converter 16 of the control mechanism 10 are cooperated with to make the actual speed yₖ follow the reference speed rₖ for dynamic response.

Take the speed control for example, the controller 14 is a speed controller. Specifically, the controller 14 is, for example but not limited to, a proportional-integral (PI) controller, a proportional-integral-derivative (PID) controller, a fuzzy controller, a fuzzy proportional-integral controller, a fuzzy proportional-integral-derivative controller, or a programmable logic controller (PLC). In other words, a controller that provides speed control for the motor can be used as the speed controller. In particular, since the derivative control of the proportional-integral-derivative (PID) controller is particularly sensitive to high-frequency components in the input signal, the derivative control is usually omitted in practical applications to be more stable in the steady state under larger noises, i.e., the proportional-integral (PI) controller is implemented. In which, a discrete representation of the proportional-integral (PI) controller is:

$${c}_{k} = {K}_{P} \times {e}_{k} + {K}_{P} \times \frac{T}{{T}_{I}} \times {\sum }_{j = 0}^{k} {e}_{j}$$

In which, cₖ is a speed control signal calculated by the controller 14, T is a sampling time, K_{P} is a proportional parameter, and T_{I} is an integral parameter.

Therefore, the error speed eₖ, the actual speed yₖ, and the absolute value of the target speed |Sₜ| are inputted to the proportional-integral (PI) controller to acquire the speed control signal cₖ by a proportional-integral operation. In particular, if the previous absolute value of the target speed is different from the current absolute value of the target speed, values of the

$${K}_{P} , \frac{T}{{T}_{I}} ,$$

and Σⱼ₌₀^{k}eⱼ can be adjusted according to the current acceleration and deceleration relationship.

After the speed control signal cₖ outputted from the controller 14 is acquired, the speed control signal cₖ, the actual speed yₖ, and the absolute value of the target speed |Sₜ| are inputted to the signal converter 16 to acquire the speed drive signal dₖ. In particular, the speed drive signal dₖ can he implemented by an accelerated drive signal PWMₖ and a decelerated drive signal BKₖ. In one embodiment of the present disclosure, the accelerated drive signal PWMₖ and the decelerated drive signal BKₖ of the speed drive signal dₖ may be defined as follows.

I. When a moving direction is the same and the actual speed yₖ is greater than or equal to the absolute value of the target speed |Sₜ|, i.e., yₖ≥|Sₜ|. It is assumed that the sampling time is T, a full duty cycle is D_{full}, and parameters Cₘₐₓ=1 and Cₘᵢₙ=−1. In addition, in order to implement the speed control of the moveable platform 20 accurately and in real time under vary small or vary large difference between the actual speed yₖ and the absolute value of the target speed |Sₜ|, a brake standard BrakeStd is, for example but not limited to, defined as follows.

If yₖ−|Sₜ|>¼×(maximum speed) is satisfied, BrakeStd=64.

If yₖ−|Sₜ|>¼×(maximum speed) is not satisfied, BrakeStd=8.

In which, the maximum speed is assumed to be 5850 rpm.

If the speed is normalized, i.e., the maximum speed is to be 1, then:

If yₖ−|Sₜ|>¼ is satisfied, BrakeStd=64.

If yₖ−|Sₜ|>¼ is not satisfied, BrakeStd=8.

Therefore, the accelerated drive signal PWMₖ and the decelerated drive signal BKₖ of the speed drive signal dₖ may be defined according to the speed control signal cₖ as follows.

1. if Cₘₐₓ<cₖ: PWMₖ=D_{full} and BKₖ=0.

2. if Cₘₐₓ≥cₖ≥0, three conditions could be divided as follows.

$$\begin{matrix} if {c}_{k} - {c}_{k - 1} < {C}_{min} \text{:} {PWM}_{k} = 0 and {BK}_{k} = T . & ( 1 ) \\ if {C}_{min} \leq {c}_{k} - {c}_{k - 1} < \frac{{C}_{min}}{BrakeStd} \text{:} {PWM}_{k} = 0 and {BK}_{k} = T \times \frac{{c}_{k} - {c}_{k - 1}}{{C}_{min}} . & ( 2 ) \\ if {c}_{k} - {c}_{k - 1} \geq \frac{{C}_{min}}{BrakeStd} \text{:} {PWM}_{k} = {D}_{full} \times \frac{{c}_{k}}{{C}_{max}} and {BK}_{k} = 0. & ( 3 )\end{matrix}$$

3. if 0>cₖ≥Cₘᵢₙ: PWMₖ=0 and

$${BK}_{k} = T \times \frac{{c}_{k}}{{C}_{min}} .$$

4. if Cₘᵢₙ>cₖ: PWNₖ≥0 and BKₖ=T.

For example, under the above-mentioned conditions, i.e., the moving direction is the same and the actual speed yₖ is greater than or equal to the absolute value of the target speed |Sₜ|, if Cₘₐₓ<cₖ, it means that the speed control signal cₖ provides a fully acceleration control, and therefore PWMₖ=D_{full} and BKₖ=0 of the speed drive signal dₖ outputted from the signal converter 16. At this condition, the moveable platform 20 is controlled to accelerate with the maximum acceleration capacity without braking. For example, under the above-mentioned conditions, i.e., the moving direction is the same and the actual speed yₖ is greater than or equal to the absolute value of the target speed |Sₜ|, if Cₘₐₓ≥cₖ≥0 and cₖ−cₖ₋₁<Cₘᵢₙ, it means that the speed control signal cₖ provides a fully deceleration (brake) control, and therefore PWMₖ=0 and BKₖ=T of the speed drive signal dₖ. At this condition, the moveable platform 20 is controlled to decelerate during the sampling time T, such as 40 milliseconds. For example, under the above-mentioned conditions, i.e., the moving direction is the same and the actual speed yₖ is greater than or equal to the absolute value of the target speed |Sₜ|, if Cₘₐₓ≥cₖ≥0 and

$${C}_{min} \leq {c}_{k} - {c}_{k - 1} < \frac{{C}_{min}}{BrakeStd} ,$$

it means that the speed control signal cₖ provides an intermittent deceleration (brake) control, and the time length of each brake deceleration is a proportion of the sampling time T, in which the proportion is equal to

$$\frac{{c}_{k} - {c}_{k - 1}}{{C}_{min}} .$$

That is, the time length of each brake deceleration is determined according to previous and next two speed control signals, i.e., cₖ₋₁ and cₖ. Therefore, if a difference between the previous and next two speed control signals is greater, the time length of each brake deceleration of the moveable platform 20 is longer. For example, under the above-mentioned conditions, i.e., the moving direction is the same and the actual speed yₖ is greater than or equal to the absolute value of the target speed |Sₜ|, if Cₘₐₓ≥cₖ≥0 and

$${c}_{k} - {c}_{k - 1} \geq \frac{{C}_{min}}{BrakeStd}$$

it means that the speed control signal cₖ provides a non-fully acceleration control, and an acceleration degree is a proportion of the fully acceleration (i.e., the full duty cycle D_{full}), in which the proportion is equal to

$$\frac{{c}_{k}}{{C}_{max}} .$$

That is, the acceleration degree is determined according to the speed control signal cₖ. Therefore, if the speed control signal cₖ is greater, the acceleration degree of the moveable platform 20 is greater.

For example, under the above-mentioned conditions, i.e., the moving direction is the same and the actual speed yₖ is greater than or equal to the absolute value of the target speed |Sₜ|, if 0>cₖ≥Cₘᵢₙ, it means that the speed control signal cₖ provides an intermittent deceleration (brake) control, and the time length of each brake deceleration is a proportion of the sampling time T, in which the proportion is equal to

$$\frac{{c}_{k}}{{C}_{min}} .$$

That is, the time length of each brake deceleration is determined according to speed control signal cₖ. For example, under the above-mentioned conditions, i.e., the moving direction is the same and the actual speed yₖ is greater than or equal to the absolute value of the target speed |Sₜ|, if Cₘᵢₙ>cₖ, it means that the speed control signal cₖ provides a fully deceleration (brake) control for the moveable platform 20, and therefore PWMₖ=0 and BKₖ=T of the speed drive signal dₖ. At this condition, the moveable platform 20 is controlled to decelerate during the sampling time T, such as 40 milliseconds.

II. When the moving direction is the same and the actual speed yₖ is less than the absolute value of the target speed |Sₜ|, i.e., yₖ<|Sₜ|. It is assumed that the sampling time is T, the full duty cycle is D_{full}, parameters Cₘₐₓ=1 and Cₘᵢₙ=−1, and brake standard is BrakeStd. Therefore, the accelerated drive signal PWMₖ and the decelerated drive signal BKₖ of the speed drive signal dₖ may be defined according to the speed control signal cₖ as follows.

1. if Cₘₐₓ<cₖ: PWMₖ=D_{full} and BKₖ=0.

2. if Cₘₐₓ≥cₖ≥0, three conditions could be divided as follows.

$$\begin{matrix}if {c}_{k} - {c}_{k - 1} < {C}_{min} \text{:} {PWM}_{k} = 0 and {BK}_{k} = 0. & ( 1 ) \\ if {C}_{min} \leq {c}_{k} - {c}_{k - 1} < \frac{{C}_{min}}{BrakeStd} \text{:} {PWM}_{k} = 0 and {BK}_{k} = 0. & ( 2 ) \\ if {c}_{k} - {c}_{k - 1} \geq \frac{{C}_{min}}{BrakeStd} \text{:} {PWM}_{k} = {D}_{full} \times \frac{{c}_{k}}{{C}_{max}} and {BK}_{k} = 0. & ( 3 )\end{matrix}$$

3. if 0>cₖ≥Cₘᵢₙ: PWMₖ=0 and BKₖ=0.

4. if Cₘᵢₙ>cₖ: PWMₖ=0 and BKₖ=0.

Since the major difference between the second control condition (II) and the first control condition (I) is that the actual speed yₖ is less than the absolute value of the target speed |Sₜ| in the former, the detail description is omitted here for conciseness. In particular, in the second control condition (II), the decelerated drive signals BKₖ of the speed drive signal dₖ are zero, and the accelerated drive signals PWMₖ of the speed drive signal dₖ are the same as those in the first control condition (I).

Accordingly, the acceleration and deceleration control of the forward and reverse of the moveable platform 20 can be implemented by combination and adjustment of the accelerated drive signal PWMₖ and the decelerated drive signal BKₖ. In particular, the function of the accelerated drive signal PWMₖ is equivalent to the concept of an accelerator, and the function of the decelerated drive signal BKₖ is equivalent to the concept of a brake. If the moveable platform 20 is driven by a brushless DC (BLDC) motor, the accelerated drive signal PWMₖ is provided to control a PWM pin of a motor driver board, and the decelerated drive signal BKₖ is provided to control a Start/Brake pin of the motor driver board. Therefore, the acceleration and deceleration control of the forward and reverse of the moveable platform 20 can be implemented, and the moveable platform 20 with different loads can be automatically and stably controlled.

Moreover, according to different processing abilities of the hardware, the number of braking may be controllable by designing the decelerated drive signal BKₖ in a manner of unconditional carry to a multiple of the controllable braking time, such as 5 milliseconds. Moreover, if the actual speed yₖ is less than a minimum controllable speed and the absolute value of the target speed |Sₜ| is zero, the accelerated drive signal PWMₖ is set to zero and the decelerated drive signal BKₖ is set to T. Afterward, the control mechanism of the controller 14 is reset. Until the absolute value of the target speed |Sₜ| is not zero, the control mechanism of the controller 14 is restarted. At this condition, the signal converter 16 converts the speed control signal cₖ to acquire the accelerated drive signal PWMₖ and the decelerated drive signal BKₖ of the speed drive signal dₖ, and therefore the moveable platform 20 is driven to acquire the next actual speed yₖ₊₁. In other words, the next actual speed yₖ₊₁ can be acquired by sampling the speed result outputted from the system after the reference speed rₖ is inputted and the sampling time T is expired. Finally, the closed-loop speed control is performed for the moveable platform 20 to make the speed of the moveable platform 20 reach to the desired target speed.

For example, it is assumed that the sampling time T is 40 milliseconds, which can be determined by specifications of the selected microcontroller, a pole number of the BLDG motor is 14, a minimum average speed parameter of the BLDG motor is 4, and therefore the minimum controllable speed is: 60000/40×4/14=428.57 (rpm). Further, a minimum controllable speed of the wheel is 477.17 (0.01 cm/s) according to size specifications of the wheel, such as a diameter of the wheel.

If other types of motors are driven, similar or identical functions like the PWM pin and/or the Start/Brake pin of the motor driver board can be cooperated with the accelerated drive signal PWMₖ and the decelerated drive signal BKₖ to control the speed of the motor. Take the general brushed DC motor for example, the brake deceleration control can be implemented through shorting positive and negative terminals by external circuits, and the acceleration control can be implemented by the PWM signal. Take the stepper Motor for example, the brake deceleration control can be implemented by gradually increasing the time of fixed position, and the acceleration control can be implemented by gradually decreasing the time of fixed position.

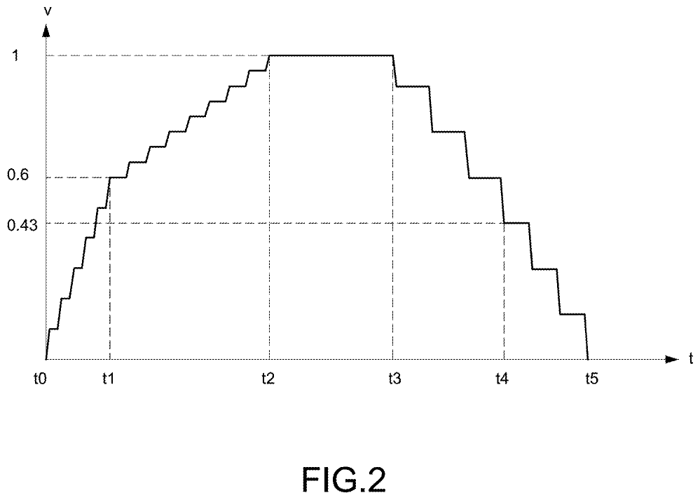

Please refer to FIG. 2, which shows a schematic waveform of a reference speed according to the present disclosure. The abscissa is time and the ordinate is speed value, and the speed value is normalized and therefore the maximum speed, such as 5850 rpm is equal to 1. From a time point t0 to a time point t1, the moveable platform 20 is accelerated under a no-loading condition. From the time point t1 to a time point t2, the moveable platform 20 is accelerated under a loading condition. The load is added on the moveable platform 20 at the time point t1. In other words, if no load is added at the time point t1, the reference speed rₖ still provides the same acceleration control as from the time point t0 to the time point t1. In particular, the time between two steps of the reference speed rₖ under the no-loading condition is shorter than that under the loading condition. From the time point t2 to a time point t3, the moveable platform 20 is driven under the target speed. From the time point t3 to a time point t4, the moveable platform 20 is decelerated under the loading condition, and from the time point t4 to a time point t5, the moveable platform 20 is decelerated under the no-loading condition. The load is removed from the moveable platform 20 at the time point t4. In other words, if the load is not removed at the time point t4, the reference speed rₖ still provides the same deceleration control as from the time point t3 to the time point t4. In particular, the time between two steps of the reference speed rₖ under the no-loading condition is shorter than that under the loading condition.

The change of the reference speed rₖ from the time point t0 to the time point t5 indicates the acceleration control and the deceleration control in the same direction. Correspondingly, if the moveable platform 20 is decelerated from the target speed (at the time point t3) to be stationary (at the time point t5) and then to be accelerated in the opposite direction, the reference speed rₖ shown in FIG. 2 can still the acceleration control and the deceleration control of the moveable platform 20, the detail description is omitted here for conciseness.

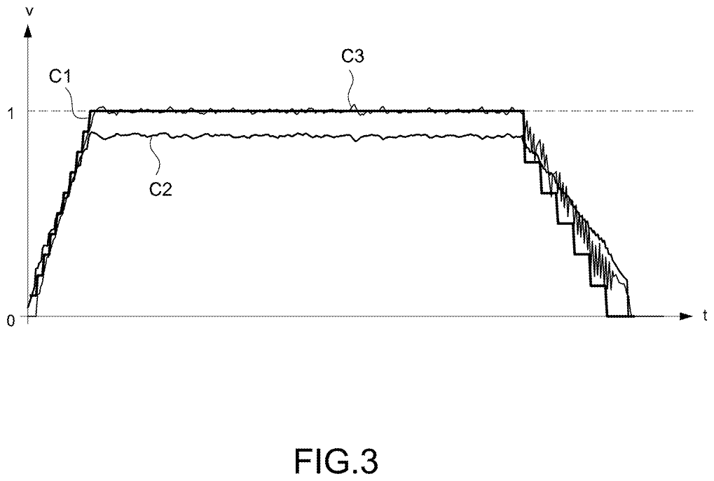

Please refer to FIG. 3, which shows a schematic waveform of a speed control of the motor-driven moveable platform according to the present disclosure. FIG. 3 shows three waveforms including a first waveform C1 of the reference speed rₖ, a second waveform C2 of the speed control signal cₖ, and a third waveform C3 of the actual speed yₖ. As mentioned in FIG. 1, the reference speed rₖ provides speed control requirements for the moveable platform 20. Further, the controller 14 is used to execute such as a proportional-integral operation to produce the speed control signal cₖ. Further, the signal converter 16 is used to convert the speed control signal cₖ to acquire the corresponding accelerated drive signal PWMₖ and the decelerated drive signal BKₖ, thereby providing a closed-loop speed control for the moveable platform 20. Accordingly, the actual speed yₖ follows the reference speed rₖ for dynamic response to make the speed of the moveable platform 20 reach to the desired target speed.

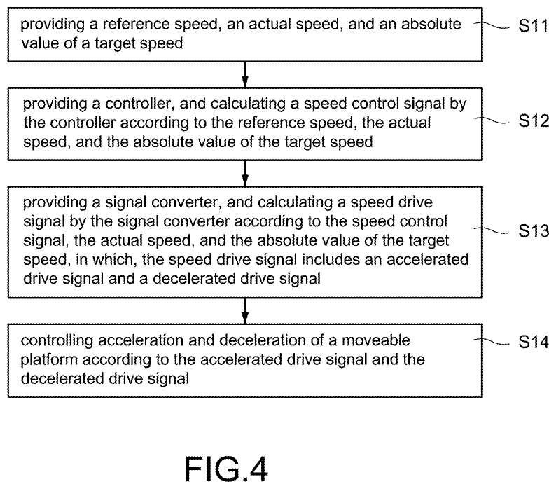

Please refer to FIG. 4, which shows a flowchart of a method of controlling the motor-driven moveable platform according to the present disclosure. The control method includes the steps as follows. First, providing a reference speed rₖ, an actual speed yₖ, and an absolute value of a target speed |Sₜ| (S11). In which, the actual speed yₖ of the moveable platform 20 may be detected by a speed sensor, and the reference speed rₖ provides speed control requirements for the moveable platform 20.

Please refer to FIG. 4, which shows a flowchart of a method of controlling the motor-driven moveable platform according to the present disclosure. The control method includes the steps as follows. First, providing a reference speed rₖ, an actual speed yₖ, and an absolute value of a target speed |Sₜ| (S11). In which, the actual speed yₖ of the moveable platform 20 may be detected by a speed sensor, and the reference speed rₖ provides speed control requirements for the moveable platform 20.

Afterward, providing a controller 14, and calculating a speed control signal cₖ by the controller 14 according to the reference speed rₖ, the actual speed yₖ, and the absolute value of the target speed |Sₜ| (S12). In which, the controller 14 is, for example but not limited to, a proportional-integral (PI) controller, a proportional-integral-derivative (PID) controller, a fuzzy controller, a fuzzy proportional-integral controller, a fuzzy proportional-integral-derivative controller, or a programmable logic controller (PLC). Specifically, a subtraction operation between the reference speed rₖ and the actual speed yₖ is performed to acquire an error speed eₖ, i.e., eₖ=rₖ−yₖ. Further, the error speed eₖ, the actual speed yₖ, and the absolute value of the target speed |Sₜ| are provided to the controller 14 to calculate the speed control signal cₖ through a proportional-integral operation by the controller 14 (take the proportional-integral (PI) controller as an example).

Afterward, providing a signal converter 16, and calculating a speed drive signal dₖ by the signal converter 16 according to the speed control signal cₖ, the actual speed yₖ, and the absolute value of the target speed |Sₜ|. In which, the speed drive signal dₖ includes an accelerated drive signal PWMₖ and a decelerated drive signal BKₖ (S13). After acquiring the speed control signal cₖ outputted from the controller 14, the signal converter 16 calculates the speed drive signal dₖ according to the received speed control signal cₖ, the actual speed yₖ, and the absolute value of the target speed |Sₜ|. Finally, controlling acceleration and deceleration of the moveable platform 20 according to the accelerated drive signal PWMₖ and the decelerated drive signal BKₖ (S14). The accelerated drive signal PWMₖ can be adjusted to 0, full duty cycle (maximum duty cycle) D_{full}, or a proportion of the full duty cycle D_{full}. The decelerated drive signal BKₖ can be adjusted to 0, sampling time T, or a proportion of the sampling time T. Therefore, the speed control of the moveable platform 20 can be implemented accurately and in real time.

In conclusion, the present disclosure has following features and advantages:

1. The deceleration of the moveable platform can be achieved without additional braking mechanism, which reduces equipment costs and maintenance costs, and reduces control complexity.

2. The closed-loop speed control for the moveable platform is implemented to achieve the speed adjustment and control automatically, accurately, and in real time.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A control system of a motor-driven moveable platform configured to control speed of a moveable platform, the control system of a motor-driven moveable platform comprising:
a subtractor configured to receive a reference speed and an actual speed, and calculate a speed difference value between the reference speed and the actual speed to acquire an error speed,
a controller configured to receive the error speed, the actual speed, and an absolute value of a target speed to calculate a speed control signal, and
a signal converter configured to receive the speed control signal, the actual speed, and the absolute value of the target speed to calculate a speed drive signal, wherein the speed drive signal comprises an accelerated drive signal and a decelerated drive signal,
wherein the accelerated drive signal and the decelerated drive signal are provided to control acceleration and deceleration of the moveable platform.

2. The control system of the motor-driven moveable platform in claim 1, wherein when a moving direction of the moveable platform is the same and the actual speed is greater than or equal to the absolute value of the target speed, the accelerated drive signal and the decelerated drive signal are defined:
$$if {C}_{max} < {c}_{k} \text{:} {PWM}_{k} = {D}_{full} and {BK}_{k} = 0 , \\ if {C}_{max} \geq {c}_{k} \geq 0 , and$$
$$if {c}_{k} - {c}_{k - 1} < {C}_{min} \text{:} {PWM}_{k} = 0 and {BK}_{k} = T , \\ if {C}_{min} \leq {c}_{k} - {c}_{k - 1} < \frac{{C}_{min}}{BrakeStd} \text{:} {PWM}_{k} = 0 and {BK}_{k} = T \times \frac{{c}_{k} - {c}_{k - 1}}{{C}_{min}} , \\ if {c}_{k} - {c}_{k - 1} \geq \frac{{C}_{min}}{BrakeStd} \text{:} {PWM}_{k} = {D}_{full} \times \frac{{c}_{k}}{{C}_{max}} and {BK}_{k} = 0 , \\ if 0 > {c}_{k} \geq {C}_{min} \text{:} {PWM}_{k} = 0 and {BK}_{k} = T \times \frac{{c}_{k}}{{C}_{min}} , \\ if {C}_{min} > {c}_{k} \text{:} {PWM}_{k} = 0 and {BK}_{k} = T ,$$
wherein PWMₖ is the accelerated drive signal, BKₖ is the decelerated drive signal, D_{full} is a full duty cycle, T is a sampling time, cₖ and cₖ₋₁ are the speed control signals, Cₘₐₓ is maximum speed parameter and equal to 1, Cₘᵢₙ is minimum speed parameter and equal to −1, and BrakeStd is a brake standard.

3. The control system of the motor-driven moveable platform in claim 1, wherein when a moving direction of the moveable platform is the same and the actual speed is less than the absolute value of the target speed, the accelerated drive signal and the decelerated drive signal are defined:
$$if {C}_{max} < {c}_{k} \text{:} {PWM}_{k} = {D}_{full} and {BK}_{k} = 0 , \\ if {C}_{max} \geq {c}_{k} \geq 0 , and$$
$$if {c}_{k} - {c}_{k - 1} < {C}_{min} \text{:} {PWM}_{k} = 0 and {BK}_{k} = 0 , \\ if {C}_{min} \leq {c}_{k} - {c}_{k - 1} < \frac{{C}_{min}}{BrakeStd} \text{:} {PWM}_{k} = 0 and {BK}_{k} = 0 , \\ if {c}_{k} - {c}_{k - 1} \geq \frac{{C}_{min}}{BrakeStd} \text{:} {PWM}_{k} = {D}_{full} \times \frac{{c}_{k}}{{C}_{max}} and {BK}_{k} = 0 , \\ if 0 > {c}_{k} \geq {C}_{min} \text{:} {PWM}_{k} = 0 and {BK}_{k} = 0 , \\ if {C}_{min} > {c}_{k} \text{:} {PWM}_{k} = 0 and {BK}_{k} = 0 ,$$
wherein PWMₖ is the accelerated drive signal, BKₖ is the decelerated drive signal, D_{full} is a full duty cycle, T is a sampling time, cₖ and cₖ₋₁ are the speed control signals, Cₘₐₓ is maximum speed parameter and equal to 1, Cₘᵢₙ is minimum speed parameter and equal to −1, and BrakeStd is a brake standard.

4. The control system of the motor-driven moveable platform in claim 2, wherein the brake standard is determined according to the actual speed, the absolute value of the target speed, and a maximum speed.

5. The control system of the motor-driven moveable platform in claim 3, wherein the brake standard is determined according to the actual speed, the absolute value of the target speed, and a maximum speed.

6. The control system of the motor-driven moveable platform in claim 4, wherein:
if yₖ−|Sₜ|>¼×vₘₐₓ is satisfied, the brake standard is a first brake parameter,
if yₖ−|Sₜ|>¼×vₘₐₓ is not satisfied, the brake standard is a second brake parameter, wherein the first brake parameter is greater than the second brake parameter,
wherein yₖ is the actual speed, |Sₜ| is the absolute value of the target speed, and vₘₐₓ is the maximum speed.

7. The control system of the motor-driven moveable platform in claim 5, wherein:
if yₖ−|Sₜ|>¼×vₘₐₓ is satisfied, the brake standard is a first brake parameter,
if yₖ−|Sₜ|>¼×vₘₐₓ is not satisfied, the brake standard is a second brake parameter, wherein the first brake parameter is greater than the second brake parameter,
wherein yₖ is the actual speed, |Sₜ| is the absolute value of the target speed, and vₘₐₓ is the maximum speed.

8. The control system of the motor-driven moveable platform in claim 2, wherein when the moveable platform is driven by a brushless DC motor, the accelerated drive signal is provided to control a PWM pin of a motor driver board, and the decelerated drive signal is provided to control a Start/Brake pin of the motor driver board.

9. The control system of the motor-driven moveable platform in claim 3, wherein when the moveable platform is driven by a brushless DC motor, the accelerated drive signal is provided to control a PWM pin of a motor driver board, and the decelerated drive signal is provided to control a Start/Brake pin of the motor driver board.

10. The control system of the motor-driven moveable platform in claim 1, wherein if the actual speed is less than a minimum controllable speed and the absolute value of the target speed is zero, the accelerated drive signal and the decelerated drive signal are defined:
PWMₖ=0 and BKₖ=T,
wherein PWMₖ is the accelerated drive signal, BKₖ is the decelerated drive signal, and T is the sampling time.

11. The control system of the motor-driven moveable platform in claim 1, wherein the controller is a proportional-integral controller, a proportional-integral-derivative controller, a fuzzy controller, a fuzzy proportional-integral controller, a fuzzy proportional-integral-derivative controller, or a programmable logic controller.

12. A method of controlling a motor-driven moveable platform, the method comprising the steps of:
(a) providing a reference speed, an actual speed, and an absolute value of a target speed,
(b) providing a controller, and calculating a speed control signal by the controller according to the reference speed, the actual speed, and the absolute value of the target speed,
(c) providing a signal converter, and calculating a speed drive signal by the signal converter according to the speed control signal, the actual speed, and the absolute value of the target speed, wherein the speed drive signal comprises an accelerated drive signal and a decelerated drive signal, and
(d) controlling acceleration and deceleration of the moveable platform according to the accelerated drive signal and the decelerated drive signal.

13. The method of controlling the motor-driven moveable platform in claim 12, wherein the step (b) further comprises:
acquiring an error speed by calculating a speed difference value between the reference speed and the actual speed.

14. The method of controlling the motor-driven moveable platform in claim 12, wherein the step (d) further comprises:
when a moving direction of the moveable platform is the same and the actual speed is greater than or equal to the absolute value of the target speed, the accelerated drive signal and the decelerated drive signal are defined:
$$if {C}_{max} < {c}_{k} \text{:} {PWM}_{k} = {D}_{full} and {BK}_{k} = 0 , \\ if {C}_{max} \geq {c}_{k} \geq 0 , and$$
$$if {c}_{k} - {c}_{k - 1} < {C}_{min} \text{:} {PWM}_{k} = 0 and {BK}_{k} = T , \\ if {C}_{min} \leq {c}_{k} - {c}_{k - 1} < \frac{{C}_{min}}{BrakeStd} \text{:} {PWM}_{k} = 0 and {BK}_{k} = T \times \frac{{c}_{k} - {c}_{k - 1}}{{C}_{min}} , \\ if {c}_{k} - {c}_{k - 1} \geq \frac{{C}_{min}}{BrakeStd} \text{:} {PWM}_{k} = {D}_{full} \times \frac{{c}_{k}}{{C}_{max}} and {BK}_{k} = 0 , \\ if 0 > {c}_{k} \geq {C}_{min} \text{:} {PWM}_{k} = 0 and {BK}_{k} = T \times \frac{{c}_{k}}{{C}_{min}} , \\ if {C}_{min} > {c}_{k} \text{:} {PWM}_{k} = 0 and {BK}_{k} = T ,$$
wherein PWMₖ is the accelerated drive signal, BKₖ is the decelerated drive signal, D_{full} is a full duty cycle, T is a sampling time, cₖ and cₖ₋₁ are the speed control signals, Cₘₐₓ is maximum speed parameter and equal to 1, Cₘᵢₙ is minimum speed parameter and equal to −1, and BrakeStd is a brake standard.

15. The method of controlling the motor-driven moveable platform in claim 12, wherein the step (d) further comprises:
when a moving direction of the moveable platform is the same and the actual speed is less than the absolute value of the target speed, the accelerated drive signal and the decelerated drive signal are defined:
$$if {C}_{max} < {c}_{k} \text{:} {PWM}_{k} = {D}_{full} and {BK}_{k} = 0 , \\ if {C}_{max} \geq {c}_{k} \geq 0 , and$$
$$if {c}_{k} - {c}_{k - 1} < {C}_{min} \text{:} {PWM}_{k} = 0 and {BK}_{k} = 0 , \\ if {C}_{min} \leq {c}_{k} - {c}_{k - 1} < \frac{{C}_{min}}{BrakeStd} \text{:} {PWM}_{k} = 0 and {BK}_{k} = 0 , \\ if {c}_{k} - {c}_{k - 1} \geq \frac{{C}_{min}}{BrakeStd} \text{:} {PWM}_{k} = {D}_{full} \times \frac{{c}_{k}}{{C}_{max}} and {BK}_{k} = 0 , \\ if 0 > {c}_{k} \geq {C}_{min} \text{:} {PWM}_{k} = 0 and {BK}_{k} = 0 , \\ if {C}_{min} > {c}_{k} \text{:} {PWM}_{k} = 0 and {BK}_{k} = 0 ,$$
wherein PWMₖ is the accelerated drive signal, BKₖ is the decelerated drive signal, D_{full} is a full duty cycle, T is a sampling time, cₖ and cₖ₋₁ are the speed control signals, Cₘₐₓ is maximum speed parameter and equal to 1, Cₘᵢₙ is minimum speed parameter and equal to −1, and BrakeStd is a brake standard.

16. The method of controlling the motor-driven moveable platform in claim 14, wherein the step (d) further comprises:
determining the brake standard according to the actual speed, the absolute value of the target speed, and a maximum speed.

17. The method of controlling the motor-driven moveable platform in claim 15, wherein the step (d) further comprises:
determining the brake standard according to the actual speed, the absolute value of the target speed, and a Maximum speed.

18. The method of controlling the motor-driven moveable platform in claim 16, wherein the step (d) further comprises:
determining the brake standard is a first brake parameter if yₖ−|Sₜ|>¼×vₘₐₓ is satisfied,
determining the brake standard is a second brake parameter if yₖ−|Sₜ|>¼×vₘₐₓ is not satisfied, wherein the first brake parameter is greater than the second brake parameter,
wherein yₖ is the actual speed, |Sₜ| is the absolute value of the target speed, and vₘₐₓ is the maximum speed.

19. The method of controlling the motor-driven moveable platform in claim 17, wherein the step (d) further comprises:
determining the brake standard is a first brake parameter if yₖ−|Sₜ|>¼×vₘₐₓ is satisfied,
determining the brake standard is a second brake parameter if yₖ−|Sₜ|>¼×vₘₐₓ is not satisfied, wherein the first brake parameter is greater than the second brake parameter,
wherein yₖ is the actual speed, |Sₜ| is the absolute value of the target speed, and vₘₐₓ is the maximum speed.

20. The method of controlling the motor-driven moveable platform in claim 12, wherein the step (d) further comprises:
determining the accelerated drive signal and the decelerated drive signal: PWMₖ=0 and BKₖ=T if the actual speed is less than a minimum controllable speed and the absolute value of the target speed is zero,
wherein PWMₖ is the accelerated drive signal, BKₖ is the decelerated drive signal, and T is the sampling time.
